(19) United States
(12) Patent Application Publication
(10) Pub. No.: US 2016/0254086 A1
(43) Pub. Date: Sep. 1, 2016

(54) COIL COMPONENT

(71) Applicant: Samsung Electro-Mechanics Co., Ltd., Suwon-si (KR)

(72) Inventors: Jin-Gu KIM, Suwon-si (KR); Ichiro OGURA, Suwon-si (KR); Hong-Won KIM, Suwon-si (KR); Seung-Wook PARK, Suwon-si (KR); Jeong-Min CHO, Seongnam-si (KR)

(73) Assignee: Samsung Electro-Mechanics Co., Ltd., Suwon-si (KR)

(21) Appl. No.: 15/054,600

(22) Filed: Feb. 26, 2016

(30) Foreign Application Priority Data
Feb. 26, 2015 (KR) 10-2015-0027195

(51) Int. Cl. H01F 27/22; H01F 27/255; H01F 27/28

(52) U.S. Cl. CPC H01F 27/22; H01F 27/2804; H01F 27/255

(57) ABSTRACT

A coil component includes an insulation layer having a coil conductor, and a magnetic-resin composite layer disposed on the insulation layer. The magnetic-resin composite layer includes a heat-dissipating filler.

### CROSS-REFERENCE TO RELATED APPLICATIONS

This application claims the benefit under 35 USC 119(a) of Korean Patent Application No. 10-2015-0027195, filed with the Korean Intellectual Property Office on Feb. 26, 2015, the disclosure of which is incorporated herein by reference in its entirety.

### BACKGROUND

1. Field

The following description relates to a coil component including a heat-dissipating element.

2. Description of Related Art

With the advancement in technology, electronic devices, such as mobile phones, home electronic appliances, personal computers, personal digital assistants (PDA) and liquid crystal displays (LCD), have transformed from being analog to being digital and have become increasingly faster due to the increased amount of processed data.

Accordingly, high-speed interfaces, such as universal serial bus (USB) 2.0,USB 3.0 and a high-definition multimedia interface (HDMI), have been widely propagated for use in various digital devices, including personal computers and high-definition digital television.

Unlike conventional general single-end transmission systems, these high-speed interfaces adopt a differential transmission system, in which signals have phases that differ by 180 degrees and are transmitted using a pair of signal lines.

In the differential transmission system, if the phase of a high-frequency signal is shifted, a common mode noise is generated and affects a nearby communication device. A common mode filter (CMF) is typically used as a coil component for filtering the common mode noise. As the common mode noise is a noise generated in a differential signal line, the common mode filter removes the common mode noise that cannot be removed using a conventional filter.

As a growing number of electronic products have faster processing speed, more functions and higher performances, a higher magnetic permeability is required for the coil components used in these electronic products. As a result, a new coil component has been presented by placing a magnetic body made of a highly magnetically permeable material above and below a coil.

However, once a current flows in the coil, the magnetic body is exposed to a hysteresis loss, which is a discharge of energy in proportion to an area of hysteresis loop. As a result, heat is generated within the coil component, causing a deterioration of magnetic flux and lowered coil properties.

Accordingly, a dire demand exists for development of a coil component having a heat-dissipating element provided therein in order to lower the temperature inside the coil component.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with an embodiment, there is provided a coil component, including: an insulation layer including a coil conductor; and a magnetic-resin composite layer disposed on the insulation layer, wherein the magnetic-resin composite layer may include a heat-dissipating filler.

The heat-dissipating filler may have a greater thermal conductivity than the magnetic-resin composite layer.

The heat-dissipating filler may be smaller than a magnetic powder in the magnetic-resin composite layer.

The heat-dissipating filler may have a plate shape.

The heat-dissipating filler may be a metal oxide including at least one of boron nitride (BN), alumina (Al₂O₃), aluminum nitride (AlN), and magnesium oxide (MgO) mixed therein.

The coil component may also include: external electrodes disposed at upper outer corners of the insulation layer, wherein the magnetic-resin composite layer may be formed between the external electrodes.

The coil component may also include: a magnetic substrate disposed below the insulation layer.

The coil conductor may include a first coil and a second coil electromagnetically coupled to each other.

In accordance with an embodiment, there is provided a coil conductor, including: an insulation layer including a coil conductor installed therein; a magnetic-resin composite layer; and a heat-transferring layer including a greater thermal conductivity than the magnetic-resin composite layer, wherein the magnetic-resin composite layer and the heat-transferring layer are laminated successively on the insulation layer.

The heat-transferring layer may include a mixture of a heat-dissipating filler and a resin.

The heat-dissipating filler may have a plate shape.

The heat-dissipating filler may be a metal oxide and may include at least one of boron nitride (BN), alumina (Al2O3), aluminum nitride (AlN) and magnesium oxide (MgO) mixed therein.

A heat-dissipating filler may be dispersed between magnetic powder in the magnetic-resin composite layer.

The magnetic-resin composite layer of a plurality of magnetic-resin composite layers and the heat-transferring layer of a plurality of heat-transferring layers may be alternately laminated.

A heat-transferring layer among the plurality of heat-resisting layers may be disposed on an uppermost layer and may be externally exposed.

A heat-dissipating filler may be dispersed in at least one of the plurality of magnetic-resin composite layer.

The coil component may also include: external electrodes disposed at upper outer corners of the insulation layer, wherein the magnetic-resin composite layer and the heat-transferring layer may be formed in between the external electrodes.

The coil component may also include: a magnetic substrate disposed below the insulation layer.

The coil conductor may include a first coil and a second coil electromagnetically coupled to each other.

Other features and aspects will be apparent from the following detailed description, the drawings, and the claims.

### BRIEF DESCRIPTION OF DRAWINGS

FIG. 1 is a perspective view showing a coil component, in accordance with a first embodiment.

FIG. 2 is a sectional view of the coil component shown in FIG. 1 along the I-I′ line.

FIG. 3 is a magnified view of the portion marked “A” in FIG. 2.

FIG. 4 is a sectional view showing a coil component, in accordance with a second embodiment.

FIG. 5 is a magnified view of the portion marked “A” in FIG. 4.

FIG. 6 is a sectional view showing a coil component, in accordance with a third embodiment.

FIG. 7 is a magnified view of the portion marked “A” in FIG. 6.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art. The terms used in the description are intended to describe certain embodiments. Unless clearly used otherwise, expressions in a singular form include the meaning of a plural form. Any characteristic, number, step, operation, element, part or combinations thereof used in the present description shall not be construed to preclude any presence or possibility of one or more other characteristics, numbers, steps, operations, elements, parts or combinations thereof.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second layer disposed above a first layer based on the orientation of the device illustrated in the drawings also encompasses the device when the device is flipped upside down in use or operation.

Hereinafter, certain embodiments are described in detail with reference to the accompanying drawings.

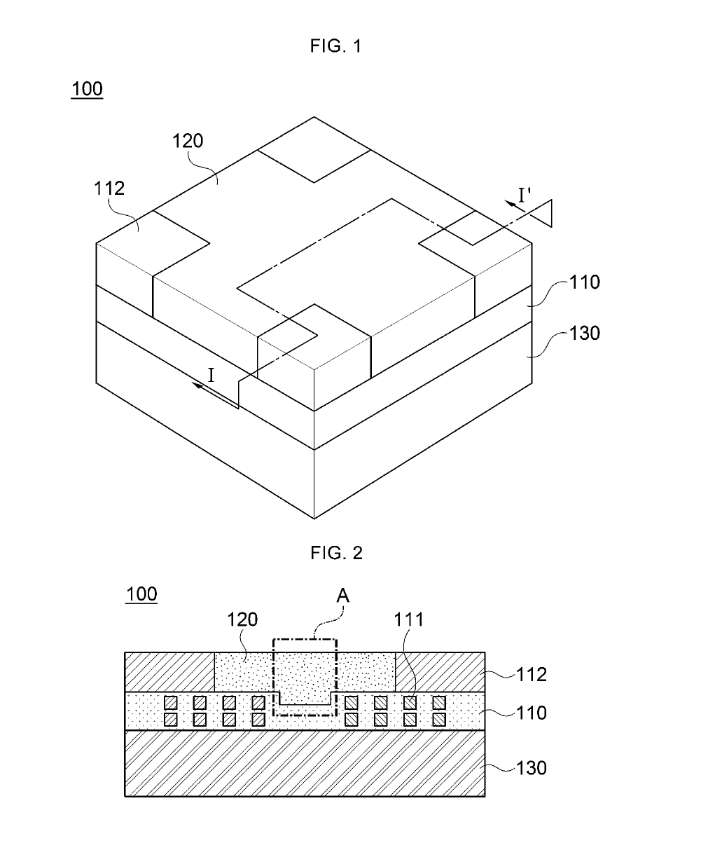

FIG. 1 is a perspective view showing a coil component, in accordance with a first embodiment. FIG. 2 is a sectional view of the coil component shown in FIG. 1 along the I-I′ line.

Referring to FIG. 1 and FIG. 2, a coil component 100, in accordance with an embodiment, includes an insulation layer 110 having a coil conductor 111 installed therein and a magnetic resin composite layer 120 disposed on the insulation layer 110.

The insulation layer 110 is formed to envelop and embed the coil conductor 111 therein so as to provide insulation between the coil conductor 111 and another coil conductor 111 and protect the coil conductor 111 from an external condition such as moisture or heat. Accordingly, the insulation layer 110 is made of a material having good heat-resisting and moisture-resisting properties as well as an insulating property, for example, epoxy resin, phenol resin, urethane resin, silicon resin or polyimide resin.

Specifically, the insulation layer 110 is formed by forming a base layer to provide a base and a flatness and then successively laminating the coil conductor 111 and a build-up layer of the insulation layer 110 covering the coil conductor 111. However, as illustrated, a boundary between layers may be integrated unidentifiably during high-temperature, high-pressure laminating and firing processes.

The coil conductor 111, which is a coil pattern of metal wire formed on a plane in a spiral form, is made of at least one of highly electrically conductive metals including, but not limited to, silver (Ag), palladium (Pd), aluminum (Al), nickel (Ni), titanium (Ti), gold (Au), copper (Cu) and platinum (Pt).

The coil conductor 111 is formed in a multilayered structure, in which plural coil conductors are separated from one another at a predetermined distance, on a same layer, and laminated repeatedly in a thickness direction. The coil conductors 111 on different layers are disposed to face opposite to each other in vertical directions to form a coil by making an interlayer connection through a via or other connecting structural element.

In an example, the coil conductor 111 is formed with a first coil and a second coil, which are electromagnetically coupled to each other and each form an individual coil. For instance, the first coil and the second coil are electromagnetically coupled to each other and are disposed above and below each other or by being alternately disposed on a same layer. Accordingly, the coil component 100 operates as a common mode filter (CMF) in which the magnetic flux is reinforced when a current is applied to the first coil and the second coil in a same direction and in which the magnetic flux is canceled out. A differential mode impedance is decreased when the current is applied to the first coil and the second coil in opposite directions.

The insulation layer 110 is laminated with a magnetic substrate 130 disposed under the insulation layer 110. That is, the magnetic substrate 130 is a plate-type support having a high modulus.

Moreover, the magnetic substrate 130 becomes a moving path of magnetic flux generated around the coil conductor 111 when a current is applied. Accordingly, the magnetic substrate 130 is made of any magnetic material as long as a predetermined inductance may be obtained, for example, a Ni-based ferrite material having Fe₂O₃ and NiO as main components, a Ni—Zn ferrite material having Fe₂O₃, NiO and ZnO as main components, or a Ni—Zn—Cu ferrite material having Fe₂O₃, NiO, ZnO and CuO as main components.

In order to better facilitate the flow of magnetic flux, a magnetic member is further provided above the insulation layer 110. However, because pad types of external electrodes 112 are formed to be externally exposed and electrically connect to an external electrical element at outer corners above the insulation layer 110, it would be difficult to dispose a solid type of magnetic member. A fluid type of magnetic member, such as a magnetic-resin composite layer 120, is instead filled in an empty space among the external electrodes 112. Accordingly, the magnetic flux around the coil conductor 111 forms a closed magnetic circuit by passing through the magnetic-resin composite layer 120 on an upper side of the coil conductor 111 and the magnetic substrate 130 on a lower side of the coil conductor 111, thus, providing a high magnetic permeability.

In an embodiment, the external terminals 112 are formed with four terminals including a pair of terminals connected to either end of the first coil, which are input and output terminals of the first coil. As part of the four terminals, the external terminals 112 also include a pair of terminals connected to either end of the second coil, which are input and output terminals of the second coil. In an example, the four external terminals 112 are disposed, respectively, near four corners of the insulation layer 110, in a clockwise or counterclockwise direction from an upper left corner of the insulation layer 110. Moreover, the insulation layer 110 has a groove formed with a predetermined depth. In the alternative, the insulation layer 110 has an opening formed to penetrate the insulation layer 110 at a center portion thereof. The magnetic-resin composite layer 120 is formed by filling and then drying a paste, which is a base material of the magnetic-resin composite layer 120. The magnetic-resin composite layer 120 has a same height as that of the external electrodes 112 in the empty space among the external electrodes 112 and the groove or opening.

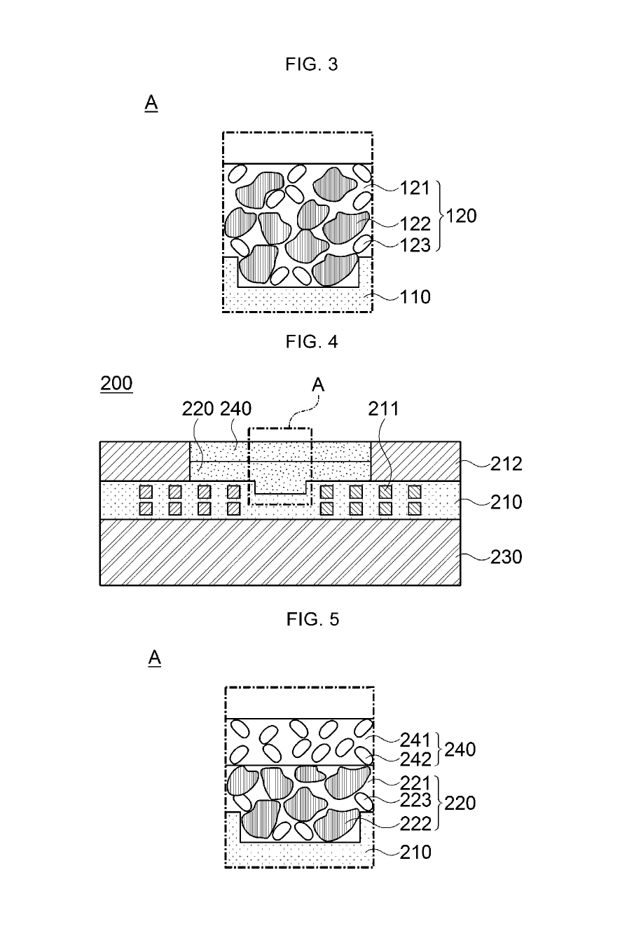

FIG. 3 is a magnified view of the portion marked “A” in FIG. 2. Referring to FIG. 3, the magnetic-resin composite layer 10 is a magnetic member in which magnetic powder 122 is contained as a filler in a polymer resin 121, which becomes a matrix. The magnetic powder 122 is further added in the magnetic-resin composite layer 10 with a heat-dissipating filler 123. That is, the heat-dissipating filler 123 is formed in a smaller size than the magnetic powder 122 and is dispersed among the magnetic powder 122.

Once a current is flowed in the coil conductor 111, a hysteresis loss, which is a discharge of energy in proportion to an area of hysteresis loop, occurs, and heat is generated within the coil component. The heat-dissipating filler 123 is a medium to transfer the heat and discharge the heat generated within the coil component to an outside or to be exposed.

In general, the magnetic-resin composite layer 120 is formed in a same height as that of the external electrodes 112. As a result, the magnetic-resin composite layer 120 has a much smaller thermal conductivity than other elements due to the heat-insulating property of the polymer resin 121, which is relatively thicker and becomes the matrix. In an embodiment, however, a temperature rise within the coil component is prevented by adding the heat-dissipating filler 123 in the magnetic-resin composite layer 120, which has a weak heat-dissipating property. Moreover, the magnetic-resin composite layer 120 is disposed on an outermost layer of the coil component. As a result, the magnetic-resin composite layer 120 has an entire upper surface thereof that is directly externally exposed. Accordingly, the heat-dissipating performance is further improved by allowing a large quantity of heat to be discharged through the upper surface and lateral surfaces of the magnetic-resin composite layer 120.

Because the heat-dissipating filler 123 carries out the function as a heat transferring path, in accord with an embodiment, the heat-dissipating filler 123 is made of a material having a greater thermal conductivity than the magnetic-resin composite layer 120. For instance, the heat-dissipating filler 123 is made of the polymer resin 121, which becomes the matrix of the magnetic-resin composite layer 120. For instance, the optimal material forming the heat-dissipating filler 123 is a metal oxide.

As described above, the magnetic-resin composite layer 120 is disposed between the four external electrodes 112 to electrically insulate the external electrodes 112 from one another. Accordingly, if the heat-dissipating filler 123 were made of a general metallic material, a conductive path would be formed by the heat-dissipating filler 123, thus, losing the insulating function. Therefore, in accordance with an embodiment, the heat-dissipating filler 123 is made of a metal oxide, for example, a mixture of at least one of boron nitride (BN), alumina (Al₂O₃), aluminum nitride (AlN) and magnesium oxide (MgO).

In accordance with an embodiment, the particle type of the heat-dissipating filler 123 may have an amorphous, a plate, a needle and chain shapes. However, the greater the contact area between the heat-dissipating fillers 123, the faster the heat moves through the heat-dissipating filler 123. Therefore, the heat-dissipating filler 123 having the plate shape offers an advantage of enabling faster heat dissipation, which makes a linear or planar contact, rather than a spherical shape, which makes a point contact.

Hereinafter, a coil component in accordance with various embodiments will be described.

FIG. 4 is a sectional view showing a coil component, in accordance with a second embodiment. FIG. 5 is a magnified view of the portion marked “A” in FIG. 4.

Referring to FIG. 4 and FIG. 5, a coil component 200, in accordance with the second embodiment, includes a coil conductor 211, which includes a first coil and a second coil. The first coil and the second coil are electromagnetically coupled to each other. The coil component 200 also includes an insulation layer 210 enveloping the coil conductor 211. The insulation layer 210 is laminated on a magnetic substrate 230 having a high modulus.

The insulation layer 210 has four external electrodes 212, which are electrically connected with input and output terminals of the first and second coils, disposed at upper outer corners thereof. A magnetic flux is generated around the coil conductor 211 when a current is supplied into the coil conductor 211 through the external electrodes 212. In an example, a heat-transferring layer 240 is a layer configured to discharge a heat generated by a hysteresis loss.

In other words, while the previous embodiment discharges the heat through the heat-dissipating filler 123 (see FIG. 3) contained in the magnetic-resin composite layer 120 (see FIG. 2), the present embodiment discharges the heat using the heat-transferring layer 240, which is a different layer from the magnetic-resin composite layer 120. Also, the heat-transferring layer 240 has a greater thermal conductivity than the magnetic-resin composite layer 120, such as a polymer resin 221 that becomes the matrix of the magnetic-resin composite layer 120.

The heat-transferring layer 240 is successively laminated on the insulation layer 210 together with the magnetic-resin composite layer 120. A metal oxide, for example, boron nitride (BN), alumina (Al₂O₃), aluminum nitride (AlN) or magnesium oxide (MgO), is added to the heat-transferring layer 240 as a heat-dissipating filler 242 to the matrix of a polymer resin 241.

The particle type of the heat-dissipating filler 242 includes one of amorphous, plate, needle or chain shapes. In an embodiment, the plate shape of heat-dissipating filler 242 has an improved thermal conductivity through an increased contact area between the heat-dissipating fillers 242.

In an example, a sum of a thickness of the magnetic-resin composite layer 220 and a thickness of the heat-transferring layer 240 are the same as that of the external electrodes 212, and a ratio of thickness between the magnetic-resin composite layer 220 and the heat-transferring layer 240 are selected by considering a correlation with the magnetic permeability. For instance, once the required magnetic permeability is satisfied by a certain thickness of the magnetic-resin composite layer 220, the heat-transferring layer 240 is formed with a remaining height, that is, a thickness corresponding to a value obtained by subtracting the thickness of the magnetic-resin composite layer 220 from the thickness of the external electrodes 212. A person of relevant skill in the art will appreciate that minor variations in the sum of the thicknesses of the magnetic-resin composite layer 220 and the heat-transferring layer 240 from the ratio of thickness between the magnetic-resin composite layer 220 and the heat-transferring layer 240 may occur. Such variations may be anywhere from 0.01% to 10% variation. Other variations may also be implemented.

As such, in an embodiment, a coil component having a high magnetic permeability with a guaranteed heat-dissipating performance is readily manufactured through an adjustment of the ratio of thickness between the magnetic-resin composite layer 220 and the heat-transferring layer 240, thereby lowering a manufacturing cost.

Moreover, the coil component, in accordance with an embodiment, also includes a heat-dissipating filler 223 dispersed in between magnetic powder 222 contained in the magnetic-resin composite layer 220, in order to further enhance the heat-dissipating performance. Accordingly, it is possible for the magnetic-resin composite layer 220 to function as a moving path of the heat, together with the heat-transferring layer 240, thus, allowing the coil component 200 to have a further enhanced heat-dissipating property.

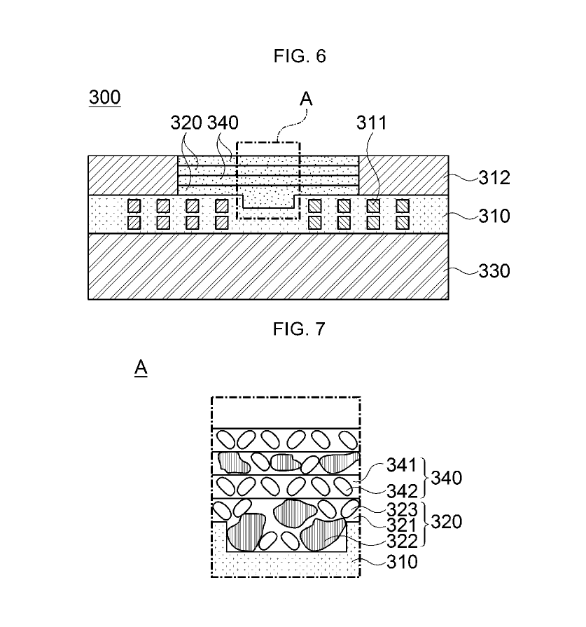

FIG. 6 is a sectional view showing a coil component, in accordance with a third embodiment. FIG. 7 is a magnified view of the portion marked “A” in FIG. 6.

Referring to FIG. 6 and FIG. 7, a coil component 300, in accordance with the third embodiment, includes a coil conductor 311, which includes a first coil and a second coil that are electromagnetically coupled with each other. The coil component 300 includes an insulation layer 310 enveloping the coil conductor 311. The insulation layer 310 is laminated on a magnetic substrate 330 having a high modulus.

The insulation layer 210 has external electrodes 312 disposed at upper outer corners thereof. A magnetic-resin composite layer 320 and a heat-transferring layer 340 are inserted in the insulation layer 210 into a space in between the external electrodes 312 by being successively laminated. In an example, the magnetic-resin composite layer 320 is a magnetic member in which magnetic powder 322 is dispersed in a polymer resin 321. The heat-transferring layer 340 is a heat-dissipating member in which a heat-dissipating filler 342 is dispersed in a polymer resin 341. In an embodiment, the magnetic-resin composite layer 320 and the heat-transferring layer 340 are each provided as single element or a plurality of elements.

The plurality of magnetic-resin composite layers 320 and the plurality of heat-transferring layers 340 are each alternately laminated. Because the heat-transferring layer 340 is an element to transfer the heat and discharge the transferred heat eventually to be externally exposed, the heat-transferring layer 340 is disposed at an outermost layer among the plurality of magnetic-resin composite layers 320 and heat-transferring layers 340. For instance, among the plurality of heat-transferring layers 340, the heat-transferring layer 340 that is placed at an uppermost layer is externally exposed and, accordingly, the heat inside the coil component is discharged to the air.

Moreover, in order to further improve the heat-dissipating performance, the coil component 300, in accordance with an embodiment, also has a heat-dissipating filler 323 dispersed in between the magnetic powder 322 contained in the magnetic-resin composite layer 320. Although it is illustrated that every magnetic-resin composite layer 320 contains the heat-dissipating filler 323, the embodiment is not limited to such configuration. In an alternative embodiment, the heat-dissipating filler 323 is contained in a particular magnetic-resin composite layer 320 or magnetic-resin composite layers 320, depending on, for example, a desired magnetic permeability.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A coil component, comprising:
an insulation layer comprising a coil conductor; and
a magnetic-resin composite layer disposed on the insulation layer,
wherein the magnetic-resin composite layer comprises a heat-dissipating filler.

2. The coil component as set forth in claim 1, wherein the heat-dissipating filler has a greater thermal conductivity than the magnetic-resin composite layer.

3. The coil component as set forth in claim 1, wherein the heat-dissipating filler is smaller than a magnetic powder in the magnetic-resin composite layer.

4. The coil component as set forth in claim 1, wherein the heat-dissipating filler has a plate shape.

5. The coil component as set forth in claim 1, wherein the heat-dissipating filler is a metal oxide comprising at least one of boron nitride (BN), alumina (Al₂O₃), aluminum nitride (AlN), and magnesium oxide (MgO) mixed therein.

6. The coil component as set forth in claim 1, further comprising:
external electrodes disposed at upper outer corners of the insulation layer,
wherein the magnetic-resin composite layer is formed between the external electrodes.

7. The coil component as set forth in claim 1, further comprising:
a magnetic substrate disposed below the insulation layer.

8. The coil component as set forth in claim 1, wherein the coil conductor comprises a first coil and a second coil electromagnetically coupled to each other.

9. A coil conductor, comprising:
an insulation layer comprising a coil conductor installed therein;
a magnetic-resin composite layer; and
a heat-transferring layer comprising a greater thermal conductivity than the magnetic-resin composite layer, wherein the magnetic-resin composite layer and the heat-transferring layer are laminated successively on the insulation layer.

10. The coil component as set forth in claim 9, wherein the heat-transferring layer comprises a mixture of a heat-dissipating filler and a resin.

11. The coil component as set forth in claim 10, wherein the heat-dissipating filler has a plate shape.

12. The coil component as set forth in claim 10, wherein the heat-dissipating filler is a metal oxide comprises at least one of boron nitride (BN), alumina (Al₂O₃), aluminum nitride (AlN) and magnesium oxide (MgO) mixed therein.

13. The coil component as set forth in claim 9, wherein a heat-dissipating filler is dispersed between magnetic powder in the magnetic-resin composite layer.

14. The coil component as set forth in claim 9, wherein the magnetic-resin composite layer of a plurality of magnetic-resin composite layers and the heat-transferring layer of a plurality of heat-transferring layers are alternately laminated.

15. The coil component as set forth in claim 14, wherein a heat-transferring layer among the plurality of heat-resisting layers is disposed on an uppermost layer and is externally exposed.

16. The coil component as set forth in claim 14, wherein a heat-dissipating filler is dispersed in at least one of the plurality of magnetic-resin composite layer.

17. The coil component as set forth in claim 9, further comprising:
external electrodes disposed at upper outer corners of the insulation layer,
wherein the magnetic-resin composite layer and the heat-transferring layer are formed in between the external electrodes.

18. The coil component as set forth in claim 9, further comprising:
a magnetic substrate disposed below the insulation layer.

19. The coil component as set forth in claim 9, wherein the coil conductor comprises a first coil and a second coil electromagnetically coupled to each other.
